(19) United States
(12) Patent Application Publication
(10) Pub. No.: US 2024/0135247 A1
(43) Pub. Date: Apr. 25, 2024

(54) Method and Apparatus for Selecting Machine Learning Model for Execution in a Resource Constraint Environment

(71) Applicant: Telefonaktiebolaget LM Ericsson (publ), Stockholm (SE)

(72) Inventors: Andreas Johnsson, Uppsala (SE); Rerngvit Yanggratoke, Järfälla (SE)

(21) Appl. No.: 18/275,310

(22) PCT Filed: Feb. 1, 2021
(86) PCT No.: PCT/EP2021/052333

§ 371 Date: Jul. 31, 2023

(51) Int. Cl. G06N 20/00

(52) U.S. Cl. CPC G06N 20/00

(57) ABSTRACT

Embodiments herein disclose a method for selecting a machine learning model to be deployed in an execution environment having resource constraints. The method comprises receiving, by an apparatus, a request for a machine learning model solving a task T using a feature set F. Further, the method includes retrieving, from a model store, a first set of machine learning models that solves the task T using at least a subset of features F. The complexity of each machine learning model in the first set of machine learning models is calculated. The method includes determining, from the first set of machine learning models, at least one suitable machine learning model to be deployed, wherein the determining is based on the calculated complexity and the resource constraints of the execution environment.

The present application relates to selecting a machine learning model for execution in a resource constraint environment.

### BACKGROUND

A long-term evolution (LTE) system, initiated by the third-generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred to as user equipment's (UEs). The UE of the LTE system can transmit and receive data on only one carrier component at any time.

5G NR (New Radio) is a new radio access technology (RAT) developed by 3GPP for the 5G (fifth generation) mobile network, and the new base station is called gNB (or gNodeB). In the current concept, the NR BS may correspond to one or more transmission and/or reception points.

Communication systems such as the LTE system or the NR has to execute a plurality of tasks for catering to increasing traffic demands and improve system throughput. Some examples of the tasks include beamforming, scheduling, Coordinated multi-point (CoMP) transmission/reception, handover decisions, etc. Most of the critical tasks are typically executed in a base station (gNB or eNB) of the LTE system or the NR. Further, for a data-driven network each task could be having a plurality of trained ML models and having varying feature sets, accuracies, complexities, data sampling requirements, and hardware requirements. Also, the LTE system or NR base stations are typically a resource-constrained system without excess memory. In such scenarios, to execute a task, it is essential to select an associated ML model that suits the resource constraints of the base station (gNB or eNB). Furthermore, some tasks have certain latency requirements in the range of 50 μs to 200 ms. Thus, it is also essential to consider the latency requirements of the task while selecting the associated ML model.

An existing solution to solve the aforementioned problem include performing field trials of ML model executions for a customer network to determine negative impacts related to the ML model. The solution includes executing a trial and collecting relevant data about resource usage and Key performance Indicators (KPIs) for the ML model. However, the solution involves additional cost for the trail, long turn-around time and pre-agreement from customers for the trails.

Another solution for selecting suitable ML models involves executing test models in a testbed. The solution includes configuring a RAN testbed with hardware, software, and traffic replication of a real RAN (of LTE system or the NR). Thereafter, the test ML models are executed with different parameters (inputs and features of the model) to collect performance data. Subsequently, a RAN expert derives a conclusion about the performance of the test model and determines the suitability of the test model for a real communication system. However, the solution requires continuous manual intervention by the RAN expert to replicate the real RAN in the testbed. Further, the real RAN is quite complex with multiple interdependent interactions, making the replication impractical and cumbersome.

Accordingly, a need exists to overcome the above-mentioned problems and to improve the throughput of the communication systems by an effective workload placement method to select a suitable ML model. Such a workload placement method should consider the resource constraints of the communication system and the latency requirements of the task.

### SUMMARY

The aforementioned needs are met by the features of the independent claims. Further aspects are described in the dependent claims. The effective workload placement in any communication system could be achieved by selecting a trained machine learning model (hereafter referred to as ML model) for executing a task, where the ML model satisfies the resource constraints of the communication system and the latency requirements of the task. The embodiments herein could be extended to any execution environment such as IoT systems and are not limited to communication systems.

According to a first aspect of the present disclosure there is provided a method for selecting a machine learning model to be deployed in an execution environment having resource constraints. The method comprises receiving, by an apparatus, a request for a machine learning model solving a task T using a feature set F. Further, the method comprises retrieving, from a model store, a first set of machine learning models that solves the task T using at least a subset of features F. The complexity of each machine learning model in the first set of machine learning models is calculated. The method comprises determining, from the first set of machine learning models, at least one suitable machine learning model to be deployed, wherein the determining is based on the calculated complexity and the resource constraints of the execution environment.

According to a second aspect of the present disclosure, there is provided an apparatus for selecting a machine learning model to be deployed in an execution environment having resource constraints. The apparatus is adapted to receive a request for a machine learning model solving a task T using a feature set F. Further, the apparatus is adapted to retrieve from a model store, a first set of machine learning models that solves the task T using at least a subset of features F. The complexity of each machine learning model in the first set of machine learning models is calculated. The apparatus is adapted to determine from the first set of machine learning models, at least one suitable machine learning model to be deployed, wherein the determining is based on the calculated complexity and the resource constraints of the execution environment. The model store is communicatively coupled to the apparatus. In another embodiment, the model store could be a part of the apparatus.

According to a third aspect of the present disclosure, there is provided a computer program comprising computer-executable instructions for causing an apparatus to perform the method according to the first aspect of the present disclosure, when the computer-executable instructions are executed on a processing unit included in the apparatus.

According to a fourth aspect of the present disclosure, there is provided a computer program product comprising a computer-readable medium, where the computer-readable medium having the computer program to perform the method according to the first aspect of the invention.

Certain embodiments may provide one or more of the following technical advantage of selecting a suitable ML model that ensures compatibility with the resource constraints of the execution environment. The embodiments herein provide a balanced performance of the execution environment without affecting performance and latency bounds. Furthermore, the embodiments herein can be easily incorporated into any network node, base station, O-RAN or IoT devices. Existing workload placement methods do not consider the specifics of ML workloads, such as model complexity, sampling overhead, and performance. Thus, the embodiments herein consider all specifics of the ML model in real-time before selecting the ML model for deployment in the execution environment. Further, the embodiments herein also consider the resource constraints of the execution environment while selecting the ML model.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts.

FIG. 1a is a schematic overview depicting an architecture according to embodiments herein;

FIG. 1b is a schematic overview depicting an architecture according to another embodiment herein;

FIG. 1c is a schematic overview depicting a model store architecture according to embodiments herein;

FIG. 1d is a block diagram of the apparatus according to embodiments herein.

FIG. 2a is a schematic flowchart depicting a method performed by the apparatus according to embodiments herein;

FIG. 2b is a schematic diagram illustrating a sequence of communication between entities according to embodiments herein; and

FIG. 3 is a schematic diagram depicting the working of a resource shortage function.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may be implemented by an indirect connection or coupling. Functional blocks may be implemented in hardware, software, firmware, or a combination thereof.

The present application addresses the problem of selecting appropriate machine learning (ML) model for executing a task in a resource-constrained execution environment such as base stations (eNB, gNB), IoT systems, or an edge computer. Some examples of the tasks include beamforming, scheduling, Coordinated multi-point (CoMP) transmission/reception, spectrum load balancing, handover decisions, and the like. Each task could have a plurality of ML models associated with varying hardware and software requirements. Thus, to avoid overloading of the resource constraint environment, it becomes essential to select a ML model that meets deployment suitability thereof. The deployment suitability may be defined by the hardware and software configuration of the resource constraint environment. The deployment requirements may also be defined by latency requirements, sampling time of features, and performance requirements of the task. It is to be noted that the term ML model is used for a trained machine learning model designed for solving a specific task.

Embodiments herein address the problem of determining at least one suitable machine learning model that can be deployed in the execution environment from a first set of ML models.

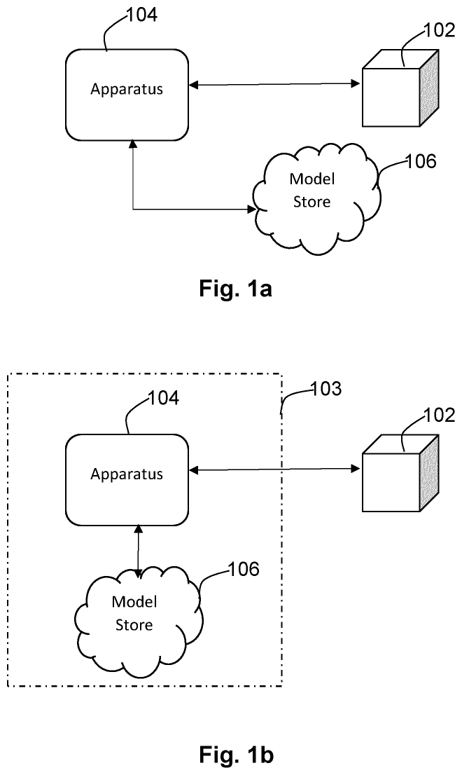

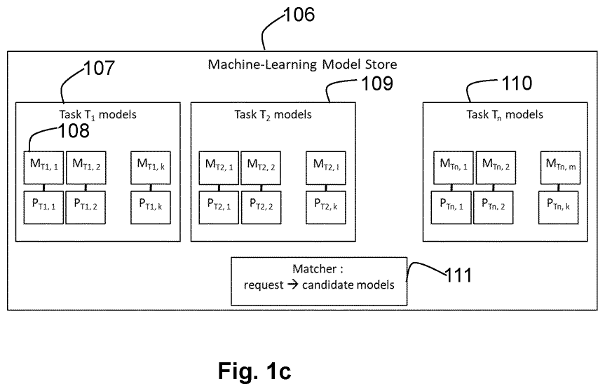

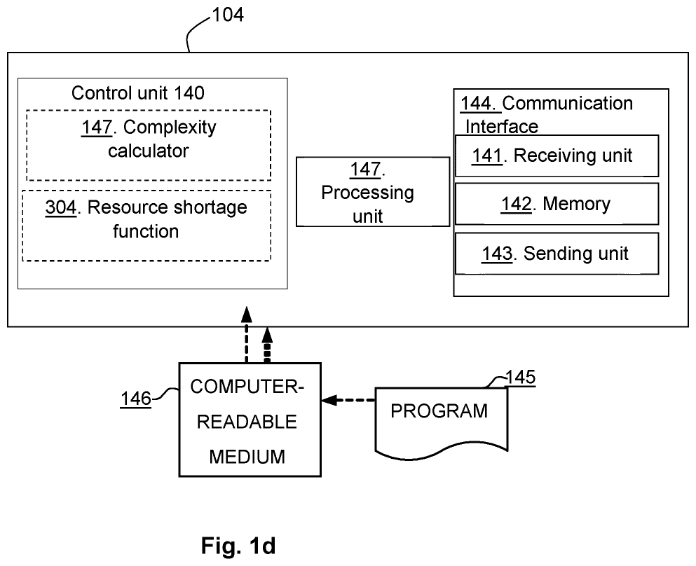

FIG. 1a depicts a schematic arrangement wherein embodiments herein may be implemented. The arrangement includes an execution environment 102 communicably coupled to an apparatus 104. In the present context, the execution environment 102 is a resource-constrained device and is understood to be a computing device with comparatively limited capabilities in terms of processing power and memory, and may also be limited with respect to the number and type(s) of interfaces for accessing, or interacting with, other devices, such as data/communication/network interfaces, user equipments and the like.

In an exemplary embodiment, the execution environment 102 may be a radio base station. The execution environment 102 may use any technology such as 5G New Radio (NR) but may further use several other different technologies, such as Wi-Fi, long term evolution (LTE), LTE-Advanced, wideband code division multiple access (WCDMA), global system for mobile communications/enhanced data rate for GSM evolution (GSM/EDGE), worldwide interoperability for microwave access (WiMAX), or ultra-mobile broadband (UMB), just to mention a few possible implementations. The execution environment 102 may comprise one or more radio network nodes providing radio coverage over a respective geographical area using antennas or similar. Thus, the radio network node may serve a user equipment (UE) 10 such as a mobile phone or similar. The geographical area may be referred to as a cell, a service area, a beam, or a group of beams. The radio network node may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router and the like.

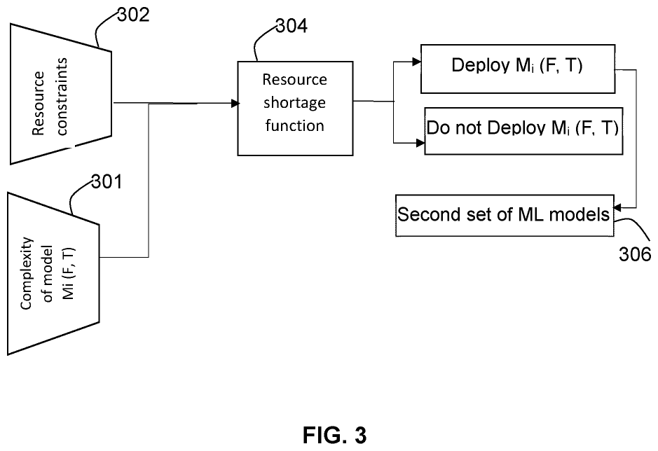

The apparatus 104 could be a server, a computer, or any computing device configured to collect and select ML models to be executed in the execution environment. The apparatus 104 may also be part of any network node, such as an edge node, a core network node, a radio network node, or similar, configured to perform computations. The apparatus 104 is communicatively coupled to a model store 106. The apparatus 104 is configured to retrieve one or more ML models for solving a task T, upon receiving a request from the execution environment. The model store 106 as shown in FIG. 1c comprises a plurality of tasks T₁, T₂, . . . Tₙ where each task (107, 109, 110 and so on) is associated with a set of machine learning models (M_{T1}, 1, M_{T1}, 2, . . . M_{T1}, k) with varying complexity and feature set properties (P_{T1,1}, P_{T1,2}, . . . P_{T1,k}). The model store 106 provides a first set of ML models 108 associated with the task T to the apparatus 104. For example, in order to execute a task T₂, the list of ML models 109 associated with the task T₂ is provided to the apparatus 104. In an example, the matching of the task to the corresponding ML model is performed by a matcher 111 (shown in FIG. 3). The matcher 111 in the model store 106 searches for ML models for solving the task T. If such a match exists in the model store 106, the matcher 111 further searches for ML models for the task T having the full or at least a subset of features F (from properties P_{T1}, P_{T2}, . . . P_{Tn}). The matcher 111 is implemented by a search algorithm that can be made with any existing database systems. Further, each match is put into the first set of ML models and provided to the apparatus 104 for further processing.

According to an embodiment, the model store 106 may be a separate entity as shown in FIG. 1a. According to another embodiment, the model store 106 may form a part of the apparatus 104 to form an entity 103 as shown in FIG. 1b.

The apparatus 104 calculates a complexity (Ci) of each machine learning model in the first set of ML models 108. Thereafter, the apparatus 104 is configured to determine a second set of ML model 306 from the first set of ML models 108 with at least one suitable machine learning model to be deployed based on the calculated complexity (Ci), and resource constraints 302 of the execution environment 102. The second set of ML model contains at least one ML model that meet deployment suitability of the execution environment 102, where the deployment suitability is defined by the hardware and software configuration of the execution environment, latency requirements, sampling time of features, and performance requirements of the task. The apparatus 104 may also assign a rank to each machine learning model in the second set of machine learning models based on their historical predictive performance. Further, the apparatus 104 selects a machine learning model with a highest rank for deployment in the execution environment 102.

According to an exemplary embodiment herein, the apparatus 104 could be part of an O-RAN architecture, where a task is executed in a RAN Intelligent Controller (Near-real-time RIC) as a trained model. In such a scenario, the apparatus 104 could be implemented in an Orchestration & automation component (of the O-RAN architecture) to function with the RAN Intelligent Controller.

The apparatus 104, may comprise an arrangement as depicted in FIG. 1d to select a machine learning model M to be deployed in an execution environment 102 having resource constraints 302,

The apparatus 104 may comprise a communication interface 144 as depicted in FIG. 1d, configured to communicate e.g. with the execution environment 102 and the model store 106. The communication interface 144 may also be configured to communicate with other communication networks or IoT devices. The communication interface 144 may comprise a wireless receiver (not shown) and a wireless transmitter (not shown) and e.g. one or more antennas. The apparatus comprises a processing unit 147 with one or more processors. The apparatus 104 may further comprise a memory 142 comprising one or more memory units to store data on. The memory 142 comprises instructions executable by the processor. The memory 412 is arranged to be used to store e.g. measurements, photos, location information, ML models, metadata, instructions, configurations and applications to perform the methods herein when being executed by the processing unit 147.

Thus, it is herein provided the apparatus 104 e.g. comprising the processing unit 147 and a memory 142, said memory 142 comprising instructions executable by said processing unit 147 whereby said apparatus 104 is operative to:
receive a request for a machine learning model solving a task T using a feature set F;
retrieve, from a model store 106, a first set of machine learning models 108 that solves the task T using at least a subset of features F;
calculate a complexity of each machine learning model in the first set of machine learning models 108;
request resource constraints from the execution environment 102;
determine, from the first set of machine learning models 108 a second set of machine learning model 306 with at least one suitable machine learning model to be deployed, wherein the determining is based on the calculated complexity and the resource constraints 302 of the execution environment 102.

The apparatus 104 may comprise a receiving unit 141, e.g. a receiver or a transceiver with one or more antennas. The processing unit 147, the apparatus 104 and/or the receiving unit 141 is configured to receive the request from the execution environment for a ML model M solving a specific task T. The apparatus 104 may comprise a sending unit 143, e.g. a receiver or a transceiver with one or more antennas. The processing unit 147, the apparatus 104 and/or the sending unit 143 is configured to transmit data requests, and selected ML model or models to the execution environment 102.

The apparatus 104 may comprise a control unit 140 with a complexity calculator 147 and the resource shortage function 304. The processing unit 147 and the complexity calculator 147 is configured to calculate the complexity of each machine learning model in the first set of machine learning models 108. The resource shortage function 304 is configured to determine the suitability of each ML model for deployment.

The embodiments herein may be implemented through a respective processor or one or more processors, such as a processor of the processing unit 147, together with a respective computer program 145 (or program code) for performing the functions and actions of the embodiments herein. The compute program 145 mentioned above may also be provided as a computer program product or a computer-readable medium 146, for instance in the form of a data carrier carrying the computer program 145 for performing the embodiments herein when being loaded into the apparatus 104. One such carrier may be in the form of a universal serial bus (USB) stick, a disc or similar. It is however feasible with other data carriers such as any memory stick. The computer program 145 may furthermore be provided as a pure program code on a server and downloaded to the apparatus 104.

Those skilled in the art will also appreciate that the units in the apparatus 104 mentioned above may refer to a combination of analog and digital circuits, and/or one or more processors configured with software and/or firmware, e.g. stored in the apparatus 104, that when executed by the respective one or more processors perform the methods described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

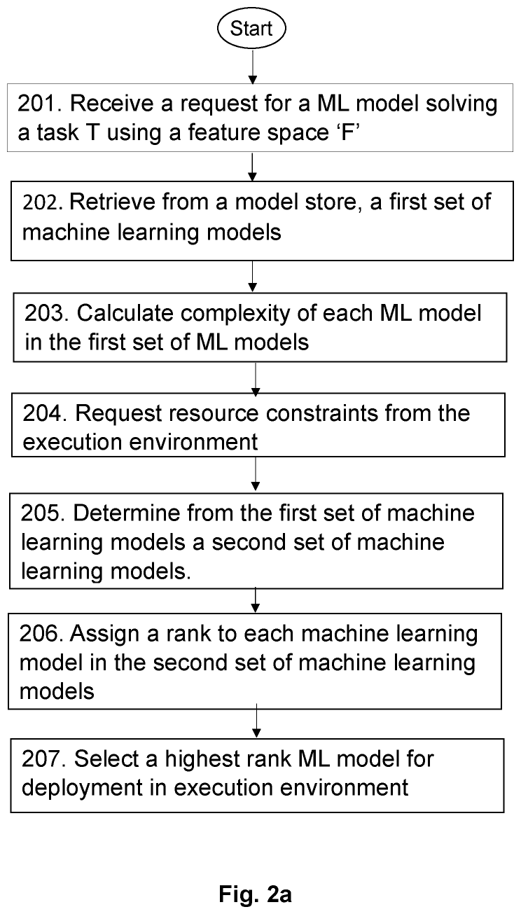

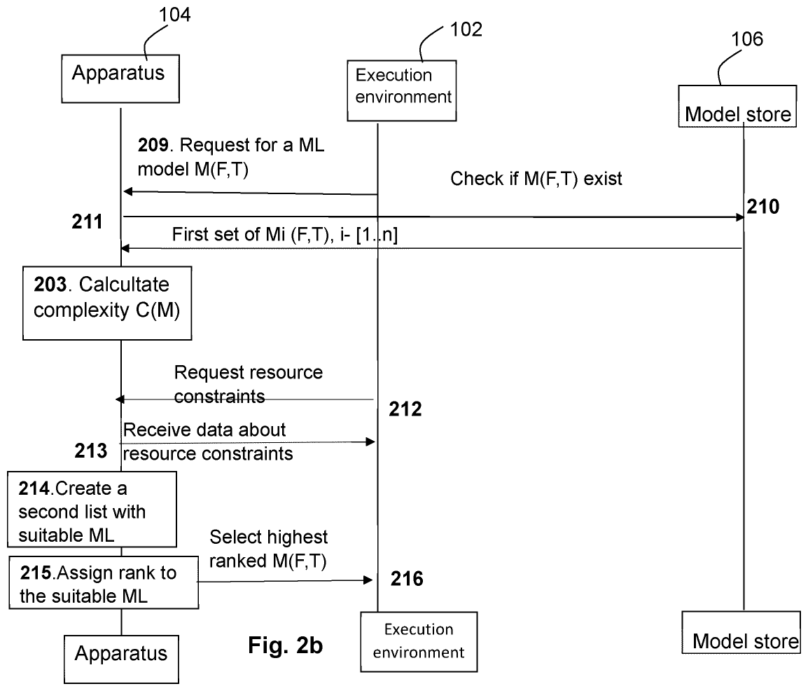

The method actions performed by the apparatus 104 for selecting a machine learning model to be deployed in the execution environment 102, according to embodiments will now be described using a flowchart depicted in FIG. 2a.

Action 201: The apparatus 104 receives a request from the execution environment for a ML model M solving a task T using a feature set F. Any task T (selected from 107, 109, 110 and so on as shown in FIG. 1c) is associated with a set of ML models (M_{T1}, 1, M_{T1}, 2, . . . M_{T1}, k) with varying complexity and feature set (feature set with properties P_{T1,1}, P_{T1,2}, . . . P_{T1,k} as shown in FIG. 1c). In an embodiment herein, the task T may also have a defined latency requirement. Some of the tasks have low latency requirements (latency in the range of 50 μs-10 ms), examples include beamforming, scheduling, spectrum management, CoMP, spectrum management, and the like. Examples of the tasks with medium latency requirements (latency in the range of 50 ms-200 ms) include handover decision, tilt optimization, Quality of Service (QoS), dual connectivity control, spectrum load balancing, and the like.

Examples of tasks with high latency requirements (latency in the range of 1 sec to days) include orchestration, programmability, optimization, analytics, automation, and the like. Each of the above-mentioned tasks would have a set of ML models with different accuraciefs, hyperparameters, complexities, feature sets, data sampling requirements, hardware requirements and software requirements.

Action 202: In this action, the apparatus 104 retrieves a first set of machine learning (ML) models 108 associated with the task T using at least a subset of features F. In order to retrieve the first set of ML model, the apparatus 104 transmits a request to the model store 106 to determine if ML models associated with the task T and using the feature set F or subset of features (from properties P_{T1}, P_{T2}, . . . P_{Tn}) exists therein. In response to the request, the model store searches for ML models solving task T having the feature set F or the subset of the features. Thereafter, the model store 106 transmits a first set of ML models 108 (Mᵢ(F, T), where Mᵢ(F, T) is the list of ML models that can be used for the task T having feature set F or subset of features and ‘i’ may vary from 1 to n) to the apparatus 104. In another exemplary embodiment, the apparatus 104 may also check whether the first set of the ML models 108 fulfill the latency requirements defined by the task T.

Action 203: In this action, the apparatus 104 determines a complexity (CO for each ML model (Mᵢ where i=1 to n)) in the first set of ML models 108. The complexity of each machine learning model is computed based on parameters comprising at least one of model parameters, model type, model size, training method, number of input features, and feature-sampling cost, some of which are elaborated below:

The model parameters correspond to the number of variables that need to be estimated during a training process. This number of variables differs depending on the model type. For example, in the case of a feed-forward single-layer neural network with three input units, five hidden units, and two output units, the number of trainable parameters is estimated by the sum of the number of connections between layers and the biases in each layer (3*5+5*2)+(5+2)=32. Thus, ML models having a higher number of model parameters such as hidden layers, input, and output units will increase the model complexity.

Another model property which is model type influences the latency of model execution. For example, a gradient boosting tree model (or boosting models in general) requires a sequential execution (depends on the depth) during inference. Another aspect of model type is the ability of a model to capture non-linear property, which adds to the complexity. For example, non-linear capable models like Support Vector Machine are more complex than linear models like linear regression.

Yet another model property which is the number of input features directly or indirectly affects the size of the trained models (to take into account the larger number of input features). Thus, trained models generally with a lower number of input features are less complex than the models with a high number of features.

Yet another model property feature sampling cost is the cost incurred for measuring input features, which adds to the complexity. In this aspect, performing data collection by measuring input features for executing a ML model can be a cumbersome and complex process. Such data collection can infer different costs to the execution environment. If we consider two trained models with a same number of model parameters, model type, and input features, the complexity could vary in both because of the cost associated with data collection.

Action 204: In this action, the apparatus 104 requests resource constraints from the execution environment 102. The resource constraints 302 comprise at least one of hardware constraints, software constraints, sampling requirements and resource usage of the execution environment.

Action 205: In this action, the apparatus 104 determines from the first set of machine learning models 108 a second set of machine learning model 306 with at least one suitable machine learning model that can be deployed. The determining is performed based on the calculated complexity and the resource constraints 302 received from the execution environment 102. In order to determine the suitable machine learning model or models, the apparatus 104 may perform a resource shortage function 304 on each machine learning model present in the first set of machine learning models 108. The resource shortage function is trained based on the calculated complexity and resource constraints as inputs to determine the suitability of each machine learning model for deployment. In an embodiment, the resource shortage function 304 checks whether the resource constraints 302 of the execution environment (for example, a base station) is compatible with each ML model (Mᵢ(F, T)). The resource shortage function 304 will be further elaborated in FIG. 3. After the execution of the resource shortage function 304, the second set of ML models (suitable to deploy) is created by the apparatus 104.

Action 206:

In this action, the apparatus 104 assigns a rank to each ML model in the second set of ML models (or suitable ML models) based on their historical predictive performance. In an example, the historic predictive performance is determined by the past performance of the ML models, which takes into consideration the accuracy and execution time of the ML model.

Action 207:

In this action, the apparatus 104 selects a highest-ranked ML model for deployment from the ranked list created in action 206. The highest-ranked ML model is selected and provided to the execution environment 102 for deployment. The selected ML model ensures compatibility with the resource constraints 302 (hardware and software configurations) of the execution environment 102.

FIG. 2b is a schematic diagram illustrating a sequence of communication between entities according to embodiments herein.

In an embodiment herein, the execution environment 102 checks whether a ML model M with feature set F is available for executing the task T in a cache memory of the execution environment 102. Such a cached ML model must comply with criteria such as expiration date, and resource constraints, or available features. If the ML model for task T with feature set F is not available in the cache, then the execution environment 102 transmits a request to the apparatus 104 for the ML model (M(F, T)) in step 209. Further, in step 210, the apparatus 104 sends a request to the model store 106 to retrieve a first set of ML models (Mᵢ(F, T), where Mᵢ(F, T) is the list of ML models that can be used for the task T having feature set F and ‘i’ may vary from 1 to n). Subsequently, in step 211, the first set of ML models (Mi(F, T), i=[1 . . . n]) is received by the apparatus 104. Thereafter, in step 203, the apparatus determines a complexity for each received model in the first set of ML models.

In step 212, the apparatus 104 further requests resource constraints 302 from the execution environment. Subsequently, in step 213, the apparatus 104 receives data about resource constraints 302. The resource constraints 302 comprise at least one of hardware constraints, software constraints, sampling requirements, active user equipment's and resource usage of the execution environment 102. The apparatus 104 further executes the resource shortage function using the resource constraints 302 and complexity of the model to check if a ML model (Mᵢ(F, T)) is compatible for deployment. In step 214, after the execution of the resource shortage function execution, the apparatus 104 creates a second set of ML models that may be deployed on the execution environment 102 without causing resource shortages. Further, in step 215, the apparatus 104 assigns a rank to each ML model in the second set of ML models based on their historical predictive performance. Thereafter, in step 216, a highest ranked ML model is selected and transmitted to the execution environment 102. Subsequently, the highest ranked ML model is deployed in the execution environment 102.

FIG. 3 is a schematic diagram that shows in further detail the working of the resource shortage function 304, according to an embodiment herein. The resource shortage function 304, which when executed by a processing unit 147 of the apparatus 104, determines the suitability of each ML model (Mᵢ(F, T)) for deployment in the execution environment 102. In an embodiment herein, the resource shortage function 304 is a trained machine learning model (e.g. using a neural network) using data about resource constraints 302. Further, the resource shortage function 304 is also trained based on the calculated complexity 301 (corresponding to a model Mᵢ(F, T)) and resource constraints 302 as inputs to determine suitability of each machine learning model for deployment.

In another embodiment herein, the resource shortage function is performed by executing a rule-based policy on each machine learning model from the first set of machine learning models, where the rule-based policy defines a preferred machine learning model for varying measures of the complexity value and the resource constraint. In an example, the rule-based policy could be programmed to analyze each ML model (Mᵢ(F, T)) based on pre-defined policies provided by a user. In yet another embodiment herein, the resource shortage function could be a dynamic function, where a neural network is updated continuously based on deployment data and historic performance of the ML models.

According to an embodiment herein, the resource shortage function 304 can be designed as illustrated in FIG. 3 with resource constraints 302 including but not limited to hardware and software configuration, resource usage, active user equipment's (UEs), complexity, frequency, and sampling requirements (of feature set F). The complexity of the ML model (Mᵢ(F, T)) is also provided to the resource shortage function 304 (for example, a neural network), which outputs a “deploy” or “not deploy” decision for the ML model (Mᵢ(F, T)). Thereafter, the resource shortage function creates a second set of ML models 306 with ML model/models that provided “deploy” as the output.

Certain embodiments may provide one or more of the following technical advantage of selecting a suitable ML model that ensures compatibility with the resource constraints of the execution environment. The embodiments herein provide a balanced performance of the execution environment without affecting performance and latency bounds. Furthermore, the embodiments herein can be easily incorporated into any network node, base station, O-RAN or IoT devices. Existing workload placement methods do not consider the specifics of ML workloads, such as model complexity, sampling overhead, and performance. Thus, the embodiments herein consider all specifics of the ML model in real-time before selecting the ML model for deployment in the execution environment. Further, the embodiments herein also consider the resource constraints of the execution environment while selecting the ML model.

When using the word “comprise” or “comprising” it shall be interpreted as non-limiting, i.e. meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-20. (canceled)

21. A method, performed by an apparatus, for selecting a machine learning model to be deployed in an execution environment having resource constraints, the method comprising:
receiving a request for a machine learning model solving a task using a feature set;
retrieving, from a model store, a first set of machine learning models that solve the task using at least a subset of features;
calculating a complexity of each machine learning model in the first set of machine learning models;
requesting resource constraints from the execution environment;
determining, from the first set of machine learning models a second set of machine learning models with at least one suitable machine learning model to be deployed, wherein the determining is based on the calculated complexity and the resource constraints received from the execution environment.

22. The method as claimed in claim 21, further comprising:
assigning a rank to each machine learning model in the second set of machine learning models based on their historical predictive performance; and
selecting a machine learning model with a highest rank assigned to be deployed in the execution environment.

23. The method as claimed in claim 21, wherein the determining comprises performing a resource shortage function on each machine learning model from the first set of machine learning models to form the second set of machine learning model, where the resource shortage function is trained based on the calculated complexity and resource constraints as inputs to determine suitability of each machine learning model for deployment.

24. The method as claimed in claim 23, wherein the resource shortage function is one of a machine learning function or a rule-based policy.

25. The method as claimed in claim 23, wherein the resource shortage function is a neural network configured to determine a suitability of each machine learning model for deployment from the first set of machine learning models.

26. The method as claimed in claim 21, wherein the step of determining comprises executing the rule-based policy on each machine learning model from the first set of machine learning models, where the rule-based policy defines a preferred machine learning model for varying measures of the complexity value and the resource constraints.

27. The method of claim 21 wherein the resource constraints comprise at least one of hardware constraints, software constraints, sampling requirements, active user equipment's and resource usage of the execution environment.

28. The method as claimed in claim 21, wherein the complexity of each machine learning model is computed based on parameters comprising at least one of model type, model size, training method, number of input features, and feature-sampling cost.

29. The method as claimed in claim 21, wherein the execution environment comprises a radio base station, an IoT device, and an edge computer.

30. An apparatus configured to select a machine learning model to be deployed in an execution environment having resource constraints, the apparatus comprising a processing unit and a memory, said memory containing program executable by said processing unit, whereby the apparatus is operative to:
receive a request for a machine learning model solving a task using a feature set;
retrieve, from a model store, a first set of machine learning models that solves the task using at least a subset of features;
calculate a complexity of each machine learning model in the first set of machine learning models;
request resource constraints from the execution environment;
determine, from the first set of machine learning models a second set of machine learning model with at least one suitable machine learning model to be deployed, wherein the determining is based on the calculated complexity and the resource constraints of the execution environment.

31. The apparatus as claimed in claim 30, wherein the model store is a component of the apparatus.

32. The apparatus as claimed in claim 30, wherein the model store is a separate entity configured to communicate with the apparatus.

33. The apparatus as claimed in claim 30, is further operative to:
assign a rank to each machine learning model in the second set of machine learning models based on their historical predictive performance; and
select a machine learning model with a highest rank to be deployed in the execution environment.

34. The apparatus as claimed in claim 30, wherein the determining comprises performing a resource shortage function on each machine learning model from the first set of machine learning models to form the second set of machine learning model, where the resource shortage function is trained based on the calculated complexity and resource constraints as inputs resource constraints as inputs to determine a suitability of each machine learning model for deployment.

35. The apparatus as claimed in claim 30, wherein the resource shortage function is one of a machine learning function or a rule-based policy.

36. The apparatus as claimed in claim 35, wherein the resource shortage function is a neural network configured to determine a suitability of each machine learning model in the first set of models for deployment.

37. The apparatus as claimed in claim 36, wherein the determining is performed by executing the rule-based policy on each machine learning model from the first set of machine learning models, where the rule-based policy defines a preferred machine learning model for varying measures of the complexity value and the resource constraint.

38. The apparatus as claimed in claim 30, wherein the resource constraints comprise at least one of: hardware constraints, software constraints, sampling requirements, active user equipment's and resource usage of the execution environment.

39. A non-transitory computer-readable medium comprising, stored thereupon, a computer program comprising computer-executable instructions for causing an apparatus to perform the steps recited in claim 21 when the computer-executable instructions are executed on a processing unit included in the apparatus.
